(19) United States
(12) Patent Application Publication
(10) Pub. No.: US 2009/0093923 A1
(43) Pub. Date: Apr. 9, 2009

(54) Status Indicator, System, and Method of Use

(76) Inventor: Marschall Scott Owens, Kingwood, TX (US)

Correspondence Address: DUANE MORRIS LLP - Houston, 3200 SOUTHWEST FREEWAY, SUITE 3150, HOUSTON, TX, 77027, US

(21) Appl. No.: 12/185,962

(22) Filed: Aug. 5, 2008

Related U.S. Application Data
(60) Provisional application No. 60/998,033, filed on Oct. 6, 2007.

(51) Int. Cl. G06F 19/00

(52) U.S. Cl. 701/29

(57) ABSTRACT

A system comprises a status indicator comprising a persistent display. The System allows unidirectional or bidirectional data transmission from a status computer to allow visual status indication of a predetermined status. In an embodiment, insurance policy status, e.g. in force or expired, is displayed on the persistent data display of a status indicator attached to a visible portion of a vehicle.

### RELATIONSHIP TO OTHER APPLICATIONS

This application claims priority through provisional 60/998,033, filed Oct. 6, 2007.

### FIELD OF THE INVENTION

The invention relates to remotely operable status indicators and a system comprising status indicators. More specifically, the invention relates to status indicators capable of communicating with a remote data source and displayable a persistent status indicator in the absence of applied power.

### BACKGROUND OF THE INVENTION

The invention relates to remotely operable status indicators. More specifically, the invention relates to removably attachable status indicators capable of communicating with a remote data source and displaying a persistent status indicator in the absence of applied power.

### BRIEF DESCRIPTION OF THE FIGURES

FIG. 1 is a simplified plan view pseudo-3D of an embodiment of the claimed invention;

FIG. 2 is a simplified block diagram of an embodiment of the claimed invention; and

FIG. 3 is a simplified block system diagram of an embodiment of the claimed invention.

### DETAILED DESCRIPTION OF VARIOUS EMBODIMENTS

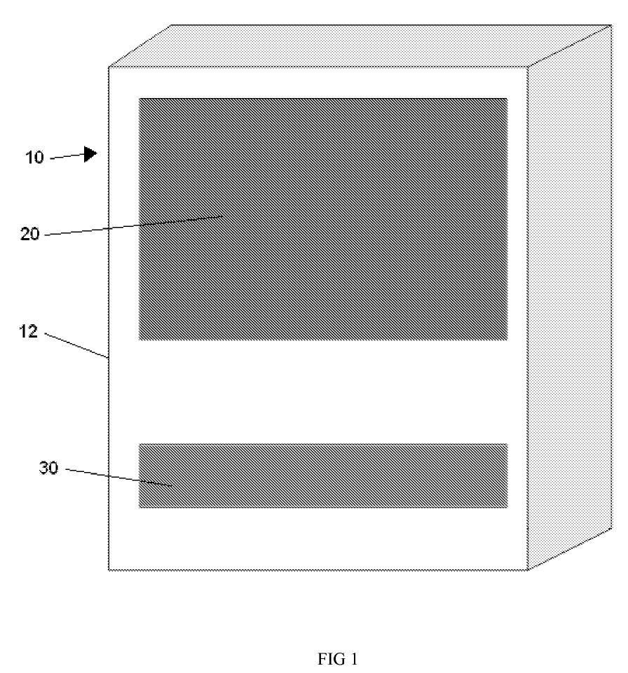

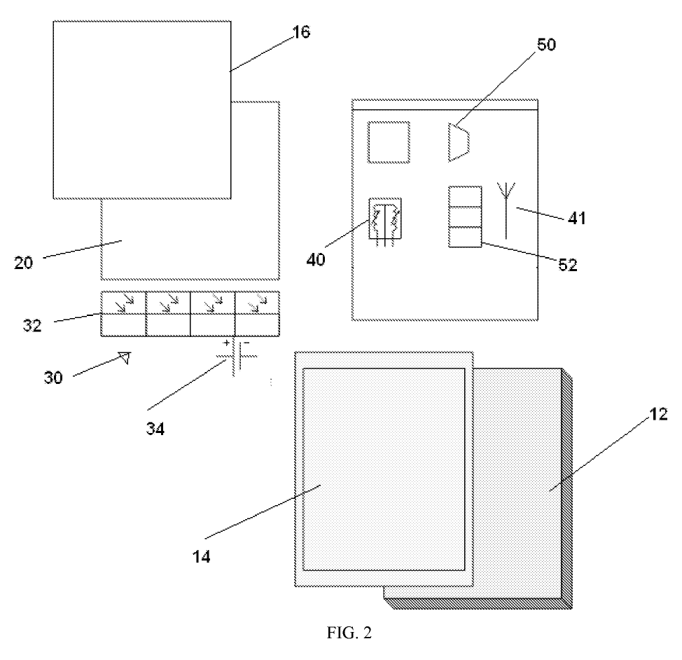

Referring now to FIG. 1, in a preferred embodiment, status indicator 1 comprises housing 12; receiver 40 (FIG. 2) at least partially disposed within housing 12; display 20 disposed proximate housing 12, display 20 configured to persist a display characteristic in the absence of applied power; memory store 52 (FIG. 2) comprising a unique status indicator device identifier; processor 50 (FIG. 2), operatively in communication with receiver 40 and display 20; and power source 30 operatively in communication with receiver 40, display 20, and processor 50.

Housing 12 is typically of a suitable material such as metal or a plastic.

Processor 50 further comprises process logic adapted to process a data signal received by receiver 40; determination logic adapted to determine if the data signal comprises a status indicator identifier that uniquely matches the unique status indicator of memory store 52; and indicator logic adapted to cause an indicator related to the processed received data signal to be displayed on display 20 as the display characteristic. As will be familiar to those of ordinary skill in the data processing arts, as used herein “logic” may be executable or interpreted software embedded in memory such as read-only memory or flash memory or the like, hardwired logic such as programmable logic arrays or the like, or a combination thereof. In FIG. 2, for example,

Referring now additionally to FIG. 2, in typical embodiments receiver 40 further comprises antenna 41. As will be familiar to those of ordinary skill in the electronics arts, receiver 40 may be a transceiver. Antenna may be of any appropriate manufacture such as an embedded antenna RF/BCM2085 manufactured by Broadcom, Inc. of Irvine, Calif. 92617 such as found at http://www.broadcom.com/products/Cellular/Cellular-RF/BCM2085.

In a currently preferred embodiment, display 20 comprises an electronic paper display. A representative electronic paper display is manufactured by E Ink Corporation of Avenue, Cambridge and described at www.eink.com.

Display 20 is typically disposed at least partially within housing 12. In certain embodiments, display 20 may be fully disposed inside housing 12 and a window or other cutout provided to allow visual access to display 20.

In certain contemplated embodiments, display 20 further comprises heat shield 16 disposed on an exposed side of display 20. Heat shield 16 is adapted to maintain visible light transmission but reduce infrared energy and ultraviolet radiation. An appropriate heat shield is the Duralan II heat shield manufactured by Silver Cloud Manufacturing Co. of Milville, N.J. and described at http://www.silver-cloud.com/products/products5.html.

Power source 30 may further comprise one or more solar cells 32 which may be operatively connected to solar powered battery 34.

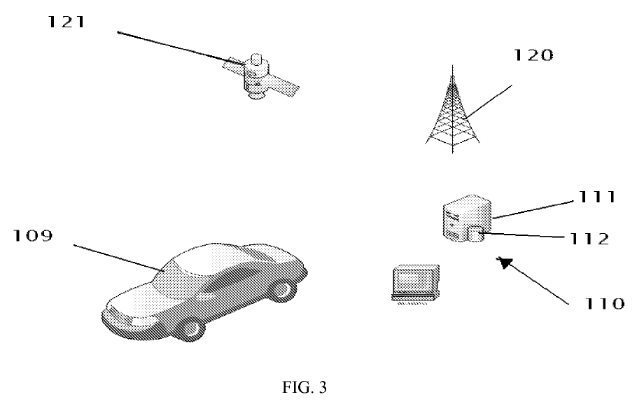

Status indicator 1 may be fixedly or removably attached to another device such as automobile 109 (FIG. 3) or other vehicle. Accordingly, status indicator 1 may further comprise fastener 14 adapted to secure housing 12 to the other device such as a vehicle. Fastener 14 may comprise an adhesive. In currently contemplated embodiments, fastener 14 allows placement and securing of status indicator 1 to a window, e.g. a vehicle's windshield.

Referring now to FIG. 3, system 100 permits controlling a visible indication of a status of a vehicle, e.g. automobile 109. System 100 comprises status computer 110, transmitter 120 (which can be or include satellite 121), status indicator 1 (as described herein above), and fastener 14 (FIG. 2).

Status computer 110 typically comprises computer 111 and database 112 which contains predetermined vehicle status and is resident in data store 113 operatively in communication with computer 111.

Transmitter 120 is operatively in communication with status computer 1 10. In currently contemplated embodiments, transmitter 120 allows for bidirectional data communication, e.g. data communication between status computer 110 and status indicator 1. In these embodiments, receiver 40 further comprises a transceiver and processor 50 further comprises response logic adapted to communicate data back to status computer 110. Data transmission is typically cellular, radio, satellite data signals transmitted from a location 200 which is remote from status indicator 1, or the like, or a combination thereof.

Fastener 14 is typically adapted to removably secure housing 12 to vehicle 109, e.g. to an interior or exterior portion of a vehicle windshield such that at least a portion of display 20 of status indicator 1 is visible from the outside of vehicle 109. However, in certain contemplated embodiments, fastener 14 is adapted to fixedly secure housing 12 to vehicle 109

In the operation of a preferred embodiment, a visible indication of a status of a device such as vehicle 109 may be provided by obtaining a predetermined status for device. For example, an insurance provider may provide a current insurance status for a vehicle, e.g. current, expired, or the like. The predetermined status is typically stored in status computer 110, e.g. in a record in database 112. At a predetermined time or interval, status computer 110 transmits data representative of the predetermined status via transmitter 120. These data comprise status data, i.e. data representative of the predetermined status for the device and an identifier associated with the status data. The identifier is typically used to associate the transmitted data stream with a single associated device.

Status indicator 1 receives the transmitted data and determines if the transmitted identifier matches a unique identifier associated with that status indicator 1, e.g. a unique identifier stored in memory store 52. If the transmitted identifier matches the unique identifier associated with status indicator 1, status indicator 1 further processes the status data, e.g. creates status indicator display data representative of the processed status data. The status indicator display data may then be displayed on display 20. By way of example and not limitation, a display characteristic may be changed to reflect the created status indicator, such as color, opacity, text, flash, or the like, or a combination thereof.

The display characteristic is then persisted, i.e. maintained, in the absence of power supplied to display 20.

In certain contemplated embodiments, status indicator 1 is programmed to contain a unique code, such as by creating a unique dataset into memory store 52 or via other alternative methods as will be familiar to those of ordinary skill in the electronics arts. The unique code may also be entered into database 112 operatively associated with status computer 110. At a predetermined time interval or set of time intervals, status computer 110 may be pinged, i.e. signaled, by status indicator 1. The time interval can be daily, hourly, on demand, or the like, or a combination thereof. In response to receiving the ping, status computer 110 sends status data to status indicator 1. Upon receipt of the status data, status indicator 1 may then send an acknowledgement signal to status computer 110. This acknowledgement signal may comprise data representative of a successful completion of the displaying of the created status indicator in response to the status received from status computer 110, data representative of an unsuccessful completion of the displaying of the created status indicator in response to the status received from status computer 110, or no response at all. A no-response may be configurably interpreted as a successful or an unsuccessful completion of the displaying of the created status indicator in response to the status received from status computer 110.

As an example of the application of system 100 and the above described method, the predetermined status may comprise current insurance status for a vehicle and the created display may indicate whether or not the current insurance status for vehicle 109 is that the insurance is in force or is expired.

The foregoing disclosure and description of the inventions are illustrative and explanatory. Various changes in the size, shape, and materials, as well as in the details of the illustrative construction and/or a illustrative method may be made without departing from the spirit of the invention.

We claim:

1. A status indicator, comprising:
a. a housing;
b. a receiver at least partially disposed within the housing;
c. a display disposed proximate the housing, the display configured to maintain a persistent display characteristic in the absence of applied power;
d. a memory store comprising a unique status indicator device identifier;
e. a processor, operatively in communication with the receiver, the display, and the memory store, the processor comprising:
i. process logic adapted to process a data signal received by the receiver;
ii. determination logic adapted to determine if the data signal comprises a status indicator identifier that uniquely matches the unique status indicator of the memory store; and
iii. indicator logic adapted to cause an indicator related to the processed received data signal to be displayed on the display as the display characteristic; and
f. a power source operatively in communication with the receiver, the display, and the processor.

2. The status indicator of claim 1, wherein the receiver further comprises an antenna.

3. The status indicator of claim 1, wherein the receiver comprises a transceiver.

4. The status indicator of claim 1, wherein the display further comprises an electronic paper display.

5. The status indicator of claim 1, wherein the display is disposed at least partially within the housing.

6. The status indicator of claim 1, wherein the power source further comprises a solar cell.

7. The status indicator of claim 6, wherein the power source further comprises a solar powered battery operatively connected to the solar cell.

8. The status indicator of claim 1, further comprising a fastener, the fastener adapted to secure the housing to a vehicle.

9. The status indicator of claim 8, wherein the fastener removably secures the housing to the vehicle.

10. The status indicator of claim 8, wherein the fastener secures the housing to a visible window of the vehicle.

11. The status indicator of claim 1, wherein the display further comprises a heat shield disposed at least partially within the housing, the heat shield adapted to maintain visible light transmission but reduce infrared energy and ultraviolet radiation.

12. A system for controlling a status of a vehicle, comprising:
a. a status computer, comprising:
i. a computer;
ii. a database of a predetermined vehicle status, the database resident in a data store operatively in communication with the computer;
b. a transmitter, operatively in communication with the status computer; and
c. a status indicator, comprising:
i. a housing;
ii. a receiver at least partially disposed within the housing;
iii. a display configured to maintain a display characteristic in the absence of applied power;
d. a processor, operatively in communication with the receiver and the display, the processor comprising:
i. process logic adapted to process a data signal received by the receiver;
ii. determination logic adapted to determine if the data signal comprises a status indicator identifier uniquely associated with the status indicator; and
iii. indicator logic adapted to cause an indicator related to the processed received data signal to be displayed via the display characteristic of display;
e. a power source operatively in communication with the receiver, the display, and the processor; and
f. a fastener, the fastener adapted to secure the housing to a vehicle.

13. The system of claim 12, wherein the fastener removably secures the housing to a vehicle.

14. The system of claim 12, wherein:
a. the system further comprises a receiver operatively in communication with the status computer;
b. the receiver further comprises a transceiver; and
c. the processor further comprises response logic adapted to communicate data back to the status computer.

15. The status indicator of claim 12, wherein the data signal is at least one of a cellular, radio or satellite data signal transmitted from a location remote from the status indicator.

16. A method of providing a status indication for a vehicle, comprising:
a. obtaining a predetermined status for a vehicle;
b. storing the predetermined status in a status computer;
c. transmitting data representative of the predetermined status via a transmitter, the data comprising status data and an identifier associated with the status data;
d. receiving the transmitted data at a status indicator, the status indicator comprising a receiver adapted to receive the transmitted data;
e. determining if the transmitted identifier matches a unique identifier associated with the status indicator;
f. processing the status data by the status indicator if the transmitted identifier matches the unique identifier associated with the status indicator;
g. creating status indicator display data representative of the processed status data; displaying a display characteristic on the created status indicator on a display associated with the status indicator; and
h. maintain the display characteristic in the absence of power supplied to the display.

17. The method of claim 16, wherein the predetermined status comprises current insurance status for a vehicle.

18. The method of claim 17, wherein the created display indicates whether or not the current insurance for the vehicle is that the insurance is in force or is expired.

19. The method of claim 16, further comprising:
a. programming a status indicator to contain a unique code;
b. entering the unique code into a database operatively associated with the status computer;
c. pinging the status computer by the status indicator at a predetermined set of times;
d. sending a status from the status computer to the status indicator in response to receiving the pinging per day to determine its status; and
e. sending an acknowledgement signal to the status computer from the status indicator.

20. The method of claim 19, wherein the acknowledgement signal is selected from the set of data signals consisting of data representative of a successful completion of the displaying of the created status indicator in response to the status received from the status computer, data representative of an unsuccessful completion of the displaying of the created status indicator in response to the status received from the status computer, no response which will be interpreted as a successful completion of the displaying of the created status indicator in response to the status received from the status computer, or no response which will be interpreted as an unsuccessful completion of the displaying of the created status indicator in response to the status received from the status computer.
